(19) United States
(12) Patent Application Publication
(10) Pub. No.: US 2020/0238958 A1
(43) Pub. Date: Jul. 30, 2020

(54) Self-Lifting Vehicle with Flood Protection, U-Turn, Parallel Parking, and Bog-Down Escape Capabilities

(71) Applicant: Xuan Chieu Pham, Winnipeg (CA)

(72) Inventor: Xuan Chieu Pham, Winnipeg (CA)

(21) Appl. No.: 16/733,464

(22) Filed: Jan. 3, 2020

Related U.S. Application Data
(60) Provisional application No. 62/797,615, filed on Jan. 28, 2019.

(30) Foreign Application Priority Data
Feb. 25, 2019 (CA) 3034836

(51) Int. Cl. B60S 9/215

(52) U.S. Cl. CPC B60S 9/215

(57) ABSTRACT

A self-lifting vehicle features a chassis, a plurality of primary ground wheels, and lifting mechanisms installed in an undercarriage of said vehicle. The lifting mechanisms feature actuators attached to the chassis of the vehicle and one or more ground-engagement units movable downwardly away from said chassis by extension of said one or more actuators to force said one or more ground engagement units downwardly against the ground, thereby elevating the chassis and lifting the primary wheels from the ground. Auxiliary wheels on the ground engagement units enable manoeuvring of the lifted vehicle in a lateral manner for parallel parking purposes, or in a swivelling manner for U-turn purposes. Other applications include flood protection, theft prevent, undercarriage service access, and tire removal.

### CROSS-REFERENCE TO RELATED APPLICATIONS

This application claims benefit under 35 U.S.C. 119(e) of U.S. Provisional Application No. 62/797,6015, filed Jan. 28, 2019, and claims benefit under 35 USC 120(a) of Canadian Patent Application 3,034,836, filed Feb. 25, 2019, both of which are incorporated herein in their entirety.

### FIELD OF THE INVENTION

The present invention relates generally to vehicles having an on-board system by which the vehicle can lift its primary ground wheels and chassis into an elevated state above ground level.

### BACKGROUND

Previously, vehicles with means for elevating some or all ground wheels of the vehicle off the ground have been limited to use on specialized work vehicles for specific work applications, for example backhoe excavators that use rear outriggers and a front bucket to exert a downforce against the ground surface to lift the ground wheels of the excavator off the ground for increased stability during digging operations. Some hi-rail vehicles (i.e. vehicles configured to enable both roadway and railway travel) feature a front set of rail wheels that are lowered down far enough to lift the steerable front road wheels of the vehicle up off the railway track, and a rear set of rail wheels that are also lowered down into contact with the rail, but by a lesser distance so as to leave the driven non-steerable rear road wheels in contact with the track to drive conveyance of the vehicle thereon.

However, applicant discloses herein novel and inventive self-lifting apparatuses and methods useful for standard passenger vehicles.

### SUMMARY OF THE INVENTION

According to a first aspect of the invention, there is provided a lifting device for a vehicle comprising a chassis, and a plurality of primary ground wheels for rollably supporting said chassis on an underlying ground surface in a normal travel mode of said vehicle, said primary ground wheels including front and rear wheels spaced apart in a longitudinal direction of the vehicle, said device comprising:
front and rear lifting mechanisms installed, or configured for installation, in an undercarriage of said vehicle in respective positions residing proximate opposing front and rear ends of the vehicle, each of said lifting mechanisms comprising:
   one or more actuators directly or indirectly attached, or configured for direct or indirect attachment, to the chassis of the vehicle; and
   a ground engagement unit attached to said one or more actuators and movable downwardly away from said chassis by operation of said one or more actuators to force said one or more ground engagement units downwardly against the ground surface and thereby lift the chassis upwardly away from said ground surface;
   said ground engagement unit comprising:
      a frame spanning, or arranged to span, in a transverse direction of transverse relation to the longitudinal direction of the vehicle;
      a driven auxiliary wheel; and
      a dedicated drive motor for said driven auxiliary wheel;
wherein two driven auxiliary wheels are of the front and rear lifting mechanisms are operable in at least a bidirectional manner rotating in opposite directions to one another.

### BRIEF DESCRIPTION OF THE DRAWINGS

One embodiment of the invention will now be described in conjunction with the accompanying drawings in which:

FIG. 1 is a schematic perspective view of a self-lifting passenger vehicle according to one embodiment of the present invention with front and rear lifting mechanisms.

FIG. 2A is a schematic rear elevational view of the rear lifting mechanism of the self-lifting passenger vehicle of FIG. 1 in a stowed position elevated from ground level.

FIG. 2B is a schematic rear elevational view of the rear lifting mechanism of FIG. 2A after initial lowering thereof to ground level.

FIG. 2C is a schematic rear elevational view of the rear lifting mechanism of FIG. 2B after further lowering thereof to lift the vehicle chassis relative to ground level.

FIG. 2D is a schematic rear elevational view of the rear lifting mechanism of FIG. 2C after further lowering thereof to lift the vehicle's primary ground wheels off the ground.

FIG. 3 is a partial front elevational view of the rear lifting mechanism of FIGS. 2A through 2D.

FIG. 4 is a cross-sectional view of the rear lifting mechanism of FIG. 3 as viewed along line IV-IV thereof.

FIG. 5 is a schematic illustration for optional powering of driven auxiliary wheels of the front and rear lifting mechanisms from the vehicle's drivetrain.

FIG. 6A is a rear elevational view of an alternate dual-actuator design for the lifting mechanisms of FIGS. 1 through 6, and also demonstrates optional use of an electric motor to power the driven auxiliary wheels thereof.

FIG. 6B is a front elevational view of the lifting mechanism of FIG. 7A.

FIG. 7A illustrates lateral entrance of the self-lifting vehicle into a parallel parking spot using driven auxiliary wheels of the lifting mechanisms.

FIG. 7B illustrates lateral departure of the self-lifting vehicle from the parallel parking spot using driven auxiliary wheels of the lifting mechanisms.

FIGS. 8A through 8C illustrates use of the driven auxiliary wheels of the self-lifting vehicle to perform a U-turn operation.

FIGS. 9A and 9B are schematic illustrates of a telescopic actuator usable on the lifting mechanisms of the present invention and incorporating a slam-down prevention device.

### DETAILED DESCRIPTION

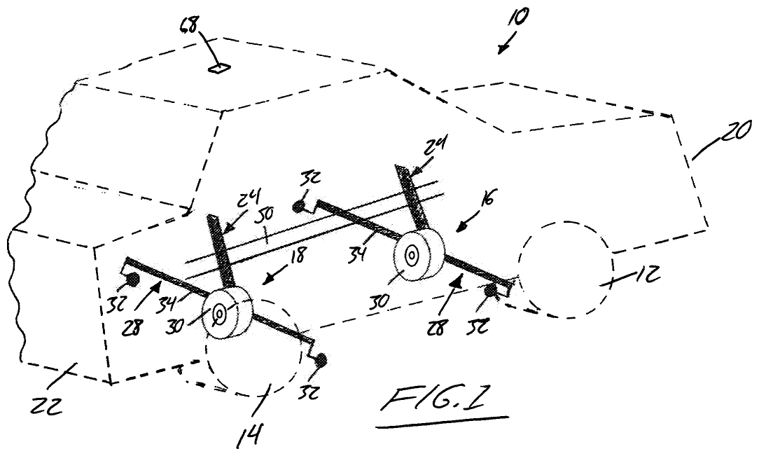

FIG. 1 shows a self-lifting passenger vehicle 10 according to one embodiment of the present invention. In conventional fashion, the vehicle 10 features a pair of steerable front ground wheels 12 and a pair of non-steerable rear ground wheels 14, of which at least one pair are powered wheels driven by a powertrain of the vehicle to convey the vehicle over a roadway or other ground surface that underlies the vehicle. These four ground wheels used for conventional road travel are also referred to herein as primary ground wheels in order to different them from additional auxiliary ground wheels described herein further below. In conventional fashion, the front primary ground wheels 12 are horizontally spaced from the rear primary ground wheels in a longitudinal direction of the vehicle. The non-steerable rear wheels 14 rotate on a horizontal rear wheel axis that lies perpendicularly transverse to the longitudinal direction. When the steerable front wheels 12 are in straight-ahead positions, they likewise rotate on a horizontal front wheel axis parallel to the rear wheel axis. Accordingly, driven rotation of either or both pairs of wheels when in contact with the roadway or other ground surface is operable to convey the vehicle forwardly and rearwardly in the longitudinal direction in a conventional manner.

However, the vehicle 10 also incorporates novel lifting mechanisms with auxiliary ground wheels by which the vehicle chassis and primary ground wheels can be elevated upwardly from their normal default positions, thus lifting the primary ground wheels upwardly out of contact with the roadway or other ground surface for various purposes described herein further below. The embodiment of FIG. 1 features two such lifting mechanisms, namely a front lifting mechanism 16 and a rear lifting mechanism 18, referred to as such due to their respective proximities to opposing front and rear ends 20, 22 of the vehicle, and/or their respective proximities to the front and rear primary ground wheels 12, 14. The body and primary ground wheels of the vehicle are shown in broken lines in FIG. 1 to enable viewing of the lift mechanisms that are installed in the vehicle's undercarriage and would therefore otherwise be obstructed from sight. While the broken line vehicle body in FIG. 1 resembles a sedan, it will be appreciated that the vehicle may be of any other variety, including a coupe, hatchback, van, pickup truck, SUV, etc.

Each lifting mechanism 16, 18 features a respective actuator 24 mounted to the chassis 26 of the vehicle, and a respective ground engagement unit 28 carried by the respective actuator 24 in a manner movable thereby relative to the vehicle chassis. Each ground engagement unit 28 features a respective set of three auxiliary ground wheels 30, 32 thereon, of which one is a driven auxiliary wheel 30 and two are non-driven idler wheels 32. Each auxiliary ground wheel is rotatable about a respective horizontal rotation axis. The rotation axis of each driven auxiliary wheel 30 is parallel to the longitudinal direction of the vehicle, i.e. perpendicular to the horizontal wheel axes of the primary rear ground wheels 14. In the illustrated example, each idler wheel 32 is a caster wheel that can swivel about an upright axis, whereby the directionality of the idler wheel's horizontal rotation axis can vary relative to the rotation axes of the driven auxiliary wheels 30 and the wheel axes of the primary rear ground wheels 14.

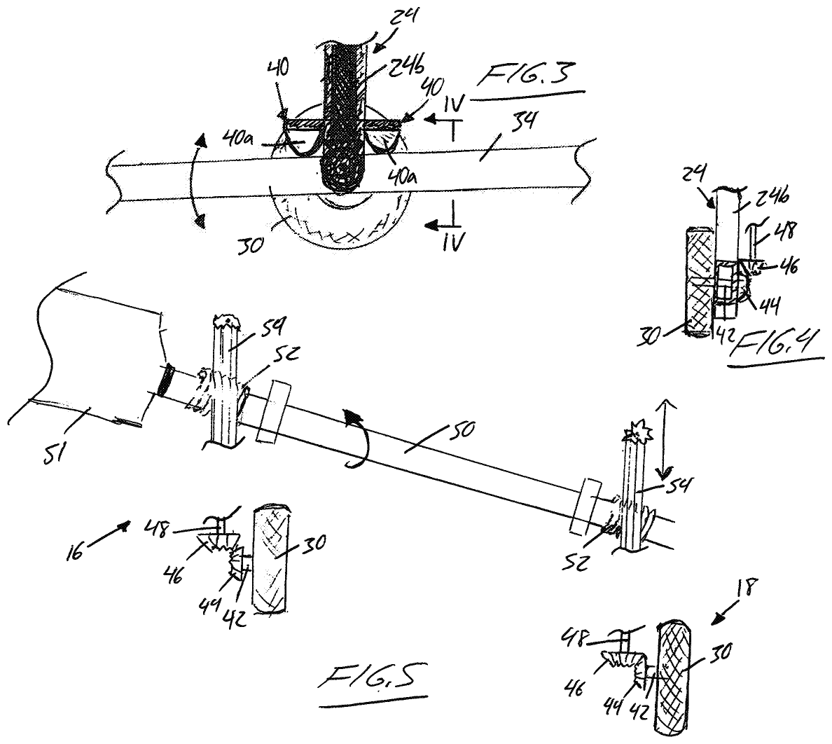

In the version shown in FIGS. 1 through 5, the ground engagement unit of each lifting mechanism features an elongated frame bar 34 that lies perpendicularly transverse to the longitudinal direction of the vehicle, and carries the respective set of auxiliary ground wheels 30, 32 at spaced apart locations in this transverse direction. Each idler wheel 32 is attached to the frame bar 34 at or near a respective terminal end thereof, while the driven auxiliary wheel 30 resides intermediately between these attachment points of the two idler wheels, preferably at a center point of the frame bar 34 midway between these attachment points. In this example, the rotational axes of the driven auxiliary wheels 30 are coincident with one another at a longitudinal midplane of the vehicle. No part of either lifting mechanism resides or protrudes outwardly beyond the footprint of the vehicle's undercarriage, and so each ground engagement unit and all the auxiliary wheels thereof reside fully within footprint of the vehicle's undercarriage. During normal driving of the vehicle, the overall lifting system formed by the two lifting mechanisms thus remains substantially concealed beneath the body of the vehicle. The system therefore doesn't detract from the vehicle's aesthetic, doesn't prevent a trip hazard to vehicle passengers entering/exiting the vehicle or to passersby, nor does it enlarge the footprint of the vehicle or present new impact hazards in the event of a vehicular accident.

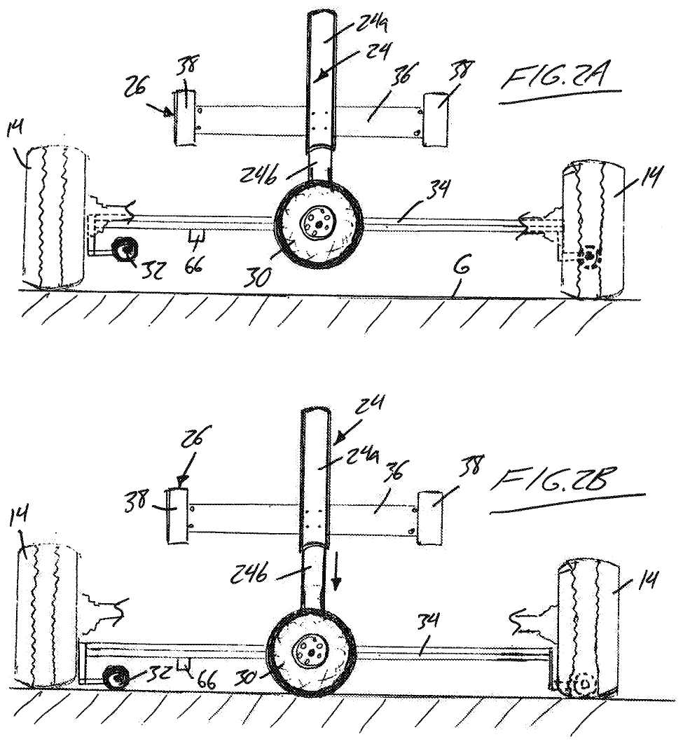

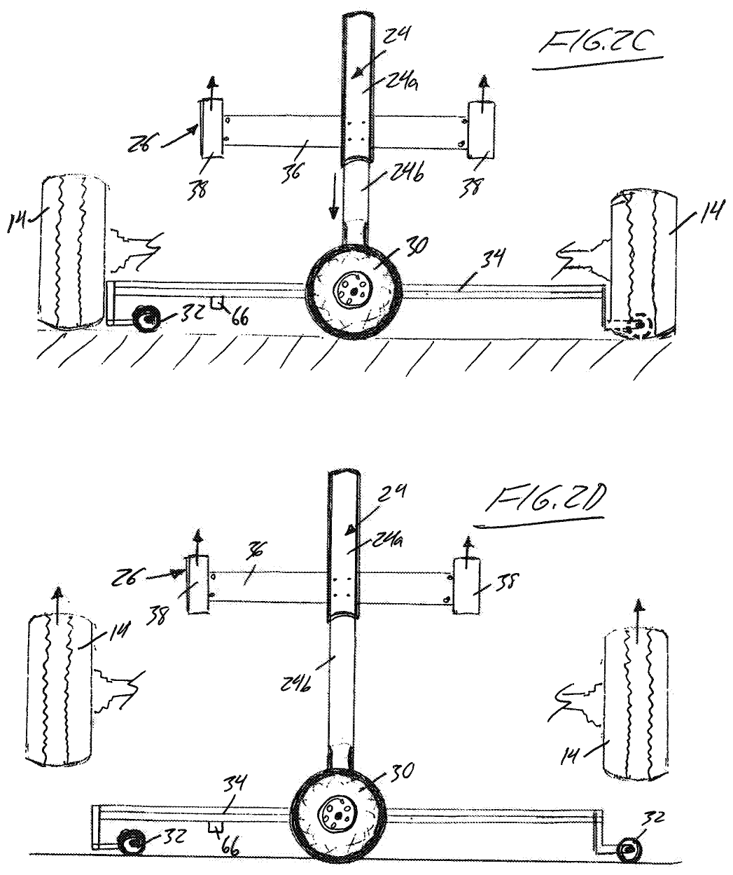

Referring to FIG. 2A, the actuator 24 of each lifting mechanism has a statically mounted housing portion 24a attached to the chassis 26 of the vehicle. For example, the housing portion 24a may be affixed to a supporting cross-member 36 that in turn is affixed to and spans transversely and perpendicularly between the two longitudinal beams or rails 38 of the chassis. An extendable/retractable working portion 24b of the actuator reaches vertically downward from the housing portion 24a, and has a pivotal connection to the elongated frame bar 34 at the mid-point thereof. The pivot axis of this connection is horizontally oriented and runs in the longitudinal direction of the vehicle, whereby the elongated frame bar 34 can pivot in a vertical plane lying perpendicularly transverse of said longitudinal direction. Accordingly, each terminal end of the elongated frame bar 34, and the respective idler wheel 32 at or near this end of the bar, can move up and down relative to the pivotally supported mid-point of the elongated frame bar 34.

FIG. 2A shows the rear lifting mechanism 18 in a normally stowed position corresponding to a fully retracted (i.e. raised) condition of the actuator's working portion 24b. The front lifting mechanism has the same structure as the rear lifting mechanism, and is operable to move between the same range of positions described for the rear lifting mechanism in relation to FIGS. 2A through 2D, and so explicit illustration and matching description of the front lifting mechanism is omitted in the interest of brevity. With each lifting mechanism this raised state, all of the auxiliary ground wheels 30, 32 are suspended in spaced elevation above ground level, while all four primary ground wheels 12, 14 of the vehicle reside at ground level to rollingly support the vehicle on the underlying ground surface G (e.g. roadway, parking lot, driveway, garage floor, etc.). In this stowed position of the two lifting mechanisms, the vehicle is thus driveable in a standard conventional manner, and so this is referred to herein as a normal driving mode of the vehicle.

FIG. 2B shows illustrates extension of the actuator 24 to drive the working portion 24b thereof, and attached frame bar 34 of the ground engagement unit, downward toward ground level, thus lowering the driven auxiliary ground wheel 30, and the two idler wheels 32, into eventual contact with the underlying ground surface G. FIG. 2C illustrates further extension of the actuator 24 to continue driving the actuator working portion 24b and ground engagement unit downwardly away from the vehicle chassis 26. Due to the already established contact of the auxiliary ground wheels 30, 32 with the ground surface G, this continued extension of the actuator 24 acts to raise the vehicle chassis 26 upwardly away from the ground surface, thus first lifting the chassis 26 relative to the primary ground wheels 12, 14 and thereby unloading the vehicle's suspension. This is shown in FIG. 2C where the chassis is rising relative to the primary ground wheels 12, 14, which remain seated at ground level. Turning to FIG. 2D, once the suspension has been fully relaxed, the continued extension of the actuator 24 now serves to also lift the primary ground wheels 12, 14 upwardly off the ground surface G, thus achieving a lifted state of the vehicle in which carrying thereof is performed entirely by the auxiliary ground wheels 30, 32 of the lifting mechanisms.

FIG. 3 shows a front view of the rear lifting mechanism, and also reflects the equivalent structure of the matching front lift mechanism. As mentioned previously, the frame bar 34 is pivotally coupled to the movable working portion 24b of the actuator 24, and is therefore pivotable about the rotation axis of the driven wheel 30 that is rotatably coupled to the frame bar 34 at the same mid-point thereof. To limit the range of pivotal movement of the frame bar 34, a pair of stoppers 40 are attached to opposing sides of the actuator's movable working portion 24b at a short distance above the pivotal connection to the frame bar 34. The stoppers 40 each block upward swinging of the respective side of the frame bar 34 beyond a predetermined limit. The stoppers preferably include pads 40a of rubber of other resilient material on the underside thereof for resiliently compressive contact between the frame bar 34 and stopper 40. The pivotal nature of the frame bar 34 allows both idler wheels 32 to maintain contact with the ground surface G in the lowered state of the lifting mechanism, even where the ground deviates from a flat planar form. Meanwhile, limiting the allowable pivot range to a relatively small value (e.g. 5-degrees) ensures that both idler wheels remain elevated above the ground in the stowed/raised position of the lifting mechanism.

FIGS. 3 to 5 illustrate one option for driven rotation of the driven auxiliary ground wheels 30 in front-engine vehicles of rear-wheel drive (RWD), all-wheel drive (AWD) or four wheel drive (4WD) configuration. In such instances, the vehicle drivetrain includes a longitudinal driveshaft 50 running rearwardly of the vehicle's undercarriage from the clutch/gearbox/transmission 51 toward the primary rear ground wheels 14. Each driven auxiliary wheel 30 is carried on a rotatable stub axle 42 that passes through the frame bar 34 at the midpoint thereof to define the wheel's rotational axis. On the side of the frame bar 34 opposite the driven wheel 30, the stub axle carries a first bevel gear 44 that intermeshes with a second bevel gear 46 on an upright transmission shaft 48 lying parallel to the actuator 24. The upright transmission shaft 48 may be of telescopic construction and attached to the extendable/retractable working portion 24b of the actuator 24 to expand and collapse with the actuator, and thereby maintain continuous mating of the bevel gears 44, 46.

Referring to FIG. 5, the transmission shaft 48 of each lifting mechanism cooperatively interfaces with the longitudinal driveshaft 50 of the vehicle's drivetrain to garner rotational drive energy therefrom. In the schematically illustrated example, this is accomplished by an intermeshing relationship between a respective worm screw 52 on the vehicle's longitudinal drive shaft 50 and cooperating worm gear teeth 54 on the outer periphery of the upright transmission shaft 48, at least at an upper region thereof where this rotational cooperation with the driveshaft 50 occurs. In embodiments where the two driven auxiliary wheels 30 must be driveable in the same direction as one another (e.g. in a unidirectional parallel parking mode, described further below), but also driveable in opposite directions to one another (e.g. in a bidirectional U-turn mode, described further below), then a suitable bi-directional drive interface would need to be implemented between the longitudinal driveshaft and the upright transmission shafts, or between the upright transmission shafts and the stub axles of the drive wheels.

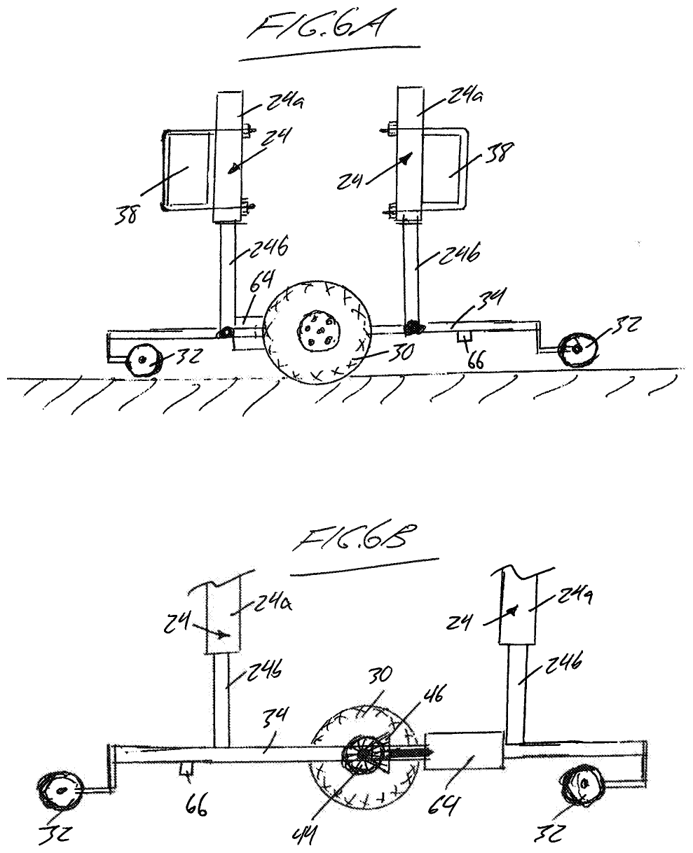

The lifting mechanisms of FIGS. 1 through 5 each employ a single actuator, and as described above, may employ the vehicle's drivetrain to power rotation of the driven auxiliary wheels 30. FIGS. 6A and 6B illustrate an alternative dual-actuator design, where each lifting mechanism features two actuators 24, whose static housing portions 24a are respectively affixed to the two longitudinal rails 38 of the vehicle chassis, and whose extendable/retractable working portions 24b are respectively coupled to the frame bar 34 of the ground engagement unit on opposite sides of the centrally mounted auxiliary driven wheel 30. The wheel engagement unit in this instance features an electric DC motor 64 mounted to the frame bar 34 on the side thereof opposite the driven wheel 30 in order to rotationally drive the second bevel gear 46 that intermeshes with the stub axle bevel gear 44 of the driven wheel 30.

So, unlike the drivetrain powered design of the earlier figures where the two lift mechanisms employ the vehicle's longitudinal driveshaft as a shared drive source for the driven auxiliary wheels 30, the FIG. 6 example instead uses a respective dedicated drive source for the driven auxiliary wheel 30 of each lifting mechanism. These DC motors 64 may be powered by the vehicle's existing battery, or by a separate, preferably rechargeable, battery based power supply of the lifting system, whether employing separate batteries for the two lifting mechanisms, or a common battery shared therebetween.

The same power supply may be used to power the actuators, for example powering a hydraulic pump in a hydraulic circuit that feeds the two lift mechanisms in embodiments where hydraulic actuators are used. Alternatively, a hydraulic pump for the actuators of the lifting mechanism may be electrically powered from the vehicle battery, or mechanically driven off the vehicle's engine. It will be appreciated that the use of DC motors to drive the auxiliary driven wheels 30 may likewise be employed in single-actuator lift mechanisms like those of the earlier figures. It will also be appreciated that where hydraulic actuators are used, hydraulic motors could optionally be used in place of electric motors for operation of the driven auxiliary wheels. Other embodiments may employ electric actuators in place of hydraulic actuators.

The above described equipping of a passenger vehicle with an on-board lifting system capable of elevating the vehicle chassis and lifting all four primary ground wheels of the vehicle off the ground has numerous useful applications.

For protecting the vehicle against flood damage, the lifting system may include a flood sensor 66, for example in the form of a respective float switch or water detection sensor mounted to one of the lifting mechanisms or to the vehicle chassis. The flood sensor is positioned at an elevation above the ground surface G but below the chassis 26, and is therefore operable to detect buildup of flood waters on the ground before the flood water level reaches the passenger cabin and engine compartment of the vehicle. The flood sensor is wired to an electronic controller of the lifting system, which may be incorporated into the vehicle's electrical system, or may be an independent unit. Triggering of the flood sensor by detected floodwater serves as an activation signal to the controller, in response to which the controller commands extension of the lifting mechanism actuators to lift the vehicle to a flood-safe elevation exceeding the detected and approaching flood waters. In addition to automated extension of the lifting mechanisms by locally detected floodwaters, a user may initiate extension of the lifting mechanisms upon receiving warning notice of anticipated flood conditions.

In such embodiments, the lifting mechanisms may be configured with actuators of notable travel to enable lifting of the vehicle a predetermined distance expected to exceed typical flood water levels, for example 4-feet off the ground. To enable such notable lift distances while still allowing stowability of the lift mechanisms in compact form under the vehicle chassis when collapsed, multi-stage telescopic actuators may be employed, where the extendable/retractable working portion features telescopic segments collapsible to a nested form substantially retracted into a static housing portion of lesser axial length than the fully extended state of the telescopic working portion.

To protect the vehicle against impact with an overlying ceiling or other overhead obstruction, an overhead obstruction sensor 68 may be mounted to the roof of the vehicle 10, as shown in FIG. 1, whether mounted directly on the roof or on any roof rack or other roof mounted accessory that may reside atop the vehicle roof and denote the uppermost extent of the overall vehicle stature. The obstruction sensor 68 is preferably a proximity sensor operable to measure a distance between the sensor and any detected overhead obstruction.

The electronic controller receives the measurement signals from the sensor and limits the extension of the actuators in response to the detected flood conditions if the obstruction sensor detects that available clearance space between the roof or roof accessory doesn't exceed the flood-safe distance by which the system would otherwise lift the vehicle by default. The default flood-safe lifting distance may be set by the mechanical limits of the actuators, or may be a programmable value of lesser magnitude than said mechanical limit. This way, impact of the lifted vehicle with an overhead obstruction (e.g. parking garage ceiling) is prevented when attempting to lift the vehicle out of the harmful path of oncoming flood waters. This impact protection may determine a safe lifting height as the detected obstruction distance minus a predetermined safety offset, for example of four-inches. So, in this example, if the default flood-safe lifting distance is four feet (48-inches), but an obstruction is detected at 40-inches above the vehicle, then the controller will prematurely terminate the lifting of the vehicle at three feet (36-inches).

In addition to impact prevention with overhead obstructions, slam-down prevention may be employed to prevent the lifted vehicle from falling suddenly in the event of power or hydraulic pressure loss, for example by way of a mechanical lock biased into a locked state when the lifting mechanisms are extended, and that will retain this locked state by default until electronically released.

FIGS. 9A and 9B illustrate an example of a slam down prevention device built into a telescopic actuator usable in the lifting mechanisms of the present invention. The actuator 24 features a series of telescopically nested cylinders 100A, 100B, 100C, 100D each having a respective ratchet bar 102A, 102B, 102C, 102D supported externally thereon by a pair of two ring-shaped mounts 104a, 104b closing circumferentially around the cylinder. Each ratchet bar lies in an axial direction of the actuator, i.e. parallel to a shared central longitudinal axis of the cylinders, and the ratchet bars all lie at an equal radial distance outward from that axis. Accordingly, the ring-shaped mounts 104a, 104b on the smaller cylinders are larger than those on the larger cylinders, as the ring-shaped mounts on the smaller cylinders must reach further outward from the respective cylinder peripheries in order to place the ratchet bars of those smaller cylinders at the same radial distance from the cylinder axis as the ratchet bars of the larger cylinders.

The upper one 104a of the two ring-shaped mounts on all but the largest one of the cylinders are axially slidable relative to the cylinders and ratchet bars so as to allow telescopic collapse of the smaller cylinders into the larger ones. On the other hand, the lower one 104b of the ring-shaped mounts on each cylinder is held at an axially fixed location thereon near the bottom end thereof, and rigidly supports the respective ratchet bar of that cylinder. The upper ring-shaped support 104a on the largest uppermost cylinder 102A that forms the stationary housing of the actuator is also axially fixed thereon, since the respective ratchet bar 102A of this cylinder doesn't move axially during extension and collapse of the actuator.

The ring-shaped mounts on all but the largest or smallest cylinder are also rotatable in a controlled manner through a small angular range about the cylinder axis, for example by electromagnetic drivers, between an engagement position mating the respective ratchet bar with the neighbouring ratchet bar on the next cylinder, and a release position disengaging the neighbouring ratchet bars from one another. The ratchet bars have teeth that, in the engaged position, mate together in the circumferential direction of the actuator in a manner allowing telescopic extension of the cylinders, but preventing telescopic collapse thereof. By default, the mounting rings and ratchet bars reside in these engaged positions, thus preventing inadvertent collapse of the actuator during and after extension thereof to prevent the lifted vehicle from slamming down to the ground in the event of an actuator failure. When controlled collapse of the actuator is required to raise up the lifting mechanism and thereby lower the vehicle back down to the ground, the ring-shaped mounts 104a, 104b are rotated into the release positions to disengage the teeth of the ratchet bars from one another to allow such controlled collapse of the actuator to take place.

The lifting system is also useful for service applications, i.e. to gain access to the undercarriage of the vehicle for inspection, maintenance and repair services, or to enable removal of one or more of the primary ground wheels, without having to use a separate vehicle lift or jack. In instances to where only front-end access is required (e.g. an oil change), one may opt activate only the front lift mechanism to raise the front primary ground wheels 12 off the ground, while leaving the rear primary ground wheels 14 on the ground. In other instances where rear end access to the undercarriage is required, one may opt to activate only the rear lift mechanism to raise the rear primary ground wheels 14 up off the ground, while leaving the front primary ground wheels 12 on the ground. Alternatively, both lift mechanisms may be activated to lift all of the primary ground wheels at the same time for full access to the entire undercarriage, or to change out or rotate all four primary ground wheels.

In this service access mode, the user may be given control over the height to which the vehicle is lifted, for example via a control panel in the vehicle that is wired to the electronic controller and presents the operator with a user interface having up and down control inputs for both lifting mechanisms, whether in the form of physical control inputs (e.g. push buttons, knobs, sliders, etc.) or virtual on-screen control inputs shown on a touch screen display. Such user interface may be dashboard or console mounted in the passenger cabin of the vehicle. In another example, the electronic controller may communicate, through wired or wireless connection, with a separate smart device (smart phone, tablet computer, etc.) running a software application that presents an on-screen user interface to the user through which control over the lifting mechanisms can be executed, for example via virtual on-screen control inputs displayed on a touch screen of said device.

Another application for the lifting system is theft prevention, where the elevated state of the primary ground wheels off the ground prevents the vehicle from being driven away. So, when the vehicle is parked, the lifting system is activated to extend the actuators far enough to lift the primary ground wheels off the ground, so that even if a would-be vehicle thief were able to start the vehicle engine, the powered primary ground wheels would merely rotate freely in the air due to their lack of contact with the ground surface. In this anti-theft mode, the vehicle is preferably elevated to a lesser height than in the aforementioned flood protection mode, since even a small degree of clearance between the primary ground wheels and underlying ground surface is sufficient prevent the vehicle from being driven forwardly or rearwardly by said powered primary ground wheels. In such anti-theft applications, preferably the ground wheels are lifted one to four inches of the ground, for example approximately two inches in one particular instance. For a front-wheel drive car, where only the front primary ground wheels are powered, the anti-theft mode of the lifting system may involve extension of only the front lifting mechanism to lift the powered front primary ground wheels off the ground. Likewise, for a rear wheel drive car, where only the rear primary ground wheels are powered, the anti-theft mode of the lifting system may involve extension of only the rear lifting mechanism to lift the powered rear primary ground wheels off the ground. In other cases, the anti-theft mode may involve extension of all lifting mechanisms to lift all four primary ground wheels, especially for an all-wheel drive or four-wheel drive vehicle.

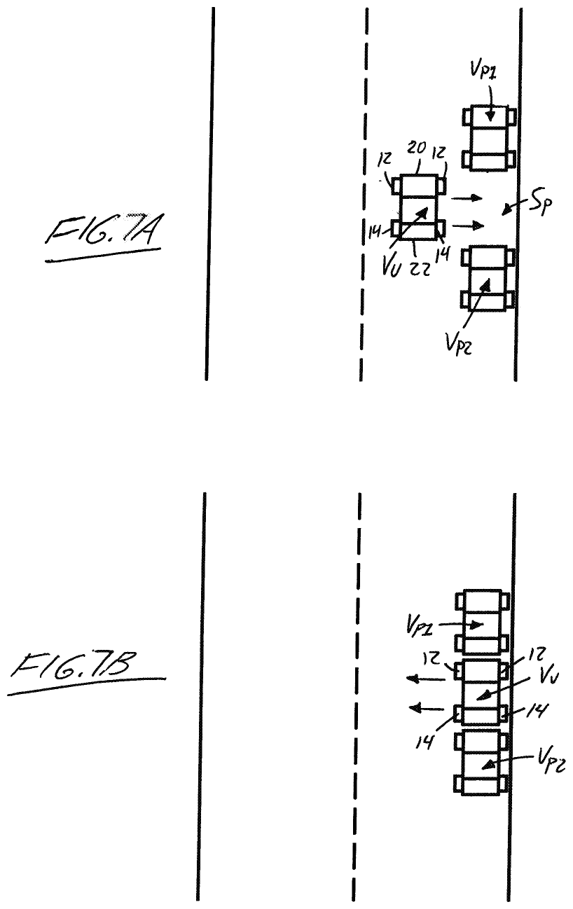

Another application for which the lifting system of the vehicle is useful is parallel parking. FIG. 7A illustrates a parallel parking situation in which two parked vehicles V_{P1} and V_{P2} are parallel parked at the side of a road, and an open space between the two vehicles is large enough to fit a user vehicle V_{U} equipped with the lifting system of the present invention, but is not large enough to enable the use to enter the spot using conventional parallel parking techniques. So instead, the user stops their vehicle directly beside the open parking space S_{P} in alignment therewith so that no part of the user vehicle V_{U} projects past the front or rear end of the parking space. With the primary ground wheels 12, 14 of the vehicle stopped, the actuators 24 of the lifting mechanisms are extended far enough to lift the primary ground wheels off the ground, and the two driven auxiliary wheels 30 are driven at the same speed as one another and in the same rotational direction toward the parking space S_{P}. Operating the driven auxiliary wheels in this unidirectional manner thus laterally conveys the vehicle into the parking space in a horizontal direction that is perpendicular to the vehicle's longitudinal travel direction and to the road's travel direction. Once again, the primary ground wheels need only be lifted a small height off the ground, for example by the same height mentioned above for the anti-theft application.

Once in the parking space, the lifting mechanisms may optionally be lifted back up into their stowed positions, thus returning the primary ground wheels to the road surface. Alternatively, the lifting mechanisms may be left deployed in their lowered positions for the theft-prevention purposes described above for the duration of time the vehicle is left parked in the parking space S_{P}. Later on, when departure from the parking space is desired, the user can simply drive away in a conventional fashion using the primary ground wheels (after raising the lifting mechanisms into the stowed position, if they had been left in the deployed positions for theft prevention), provided that sufficient space has since opened up due to the departure or repositioning of one of the two vehicles V_{P1}, V_{P2} previously parked in close proximity to the user vehicle V_{U}. Alternatively, referring to FIG. 7B, with the lifting mechanisms extended, the user can once again use the driven auxiliary wheels 30 of the vehicle V_{U} to convey the vehicle laterally, once again in a unidirectional manner, but in a direction opposite that which was previously used to park the vehicle, thus laterally conveying the vehicle out of the parking spot back into the adjacent open travel lane of the roadway.

Many modern vehicles are equipped with proximity sensors and self-parking capabilities for use in executing a conventional parallel parking technique. The electronic controller of the lifting system may be connected to the factory electronics of the vehicle to receive signals from those sensors, and use such input signals to perform additional adjustment of the vehicle position and travel direction as it enters or exits the parking space. For example, if during the parking procedure, the user stops at a position slightly non-parallel to the roadway's travel direction or roadside curb, the controller can execute asynchronous rotation of the two driven auxiliary wheels 30, where a difference in wheel rotation speed therebetween can be used to drive the vehicle on a slightly curved path to correct the alignment issue as the vehicle approaches and enters the parking spot. As an alternative to automated correction in a self-parking routine, the user of the vehicle may use steering inputs of the lifting system's user interface to likewise perform such alignment correction manoeuvres during the parking process.

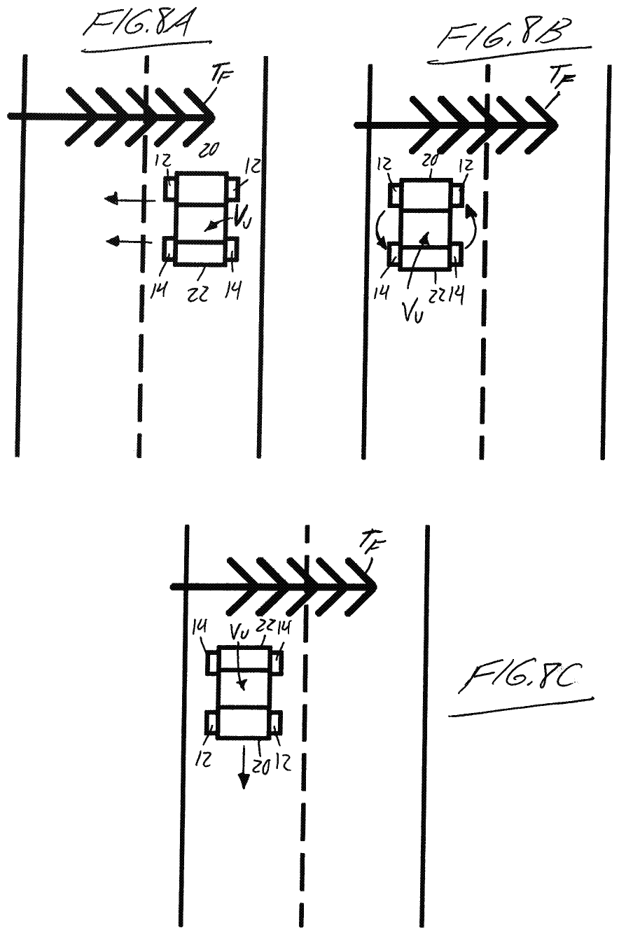

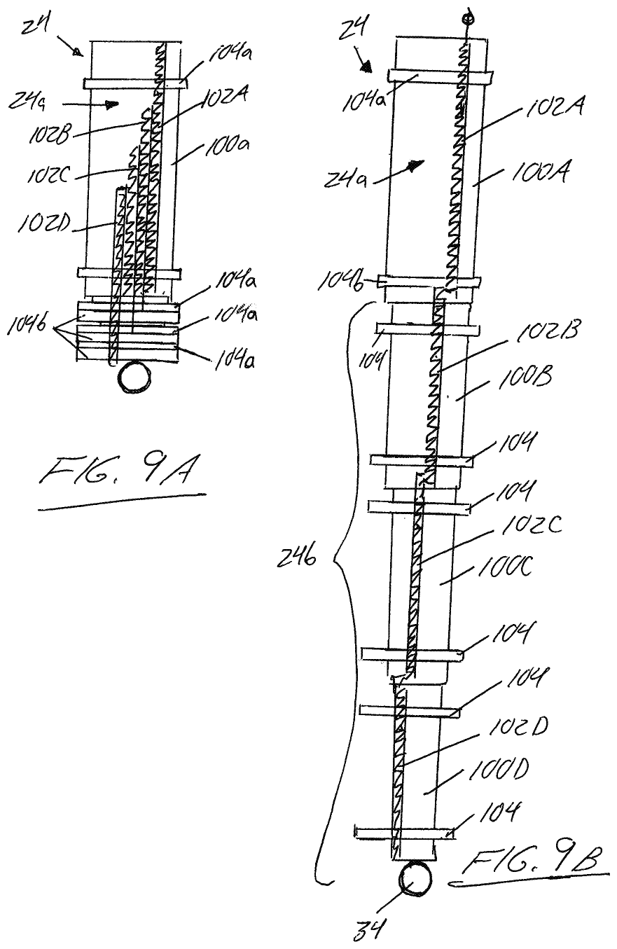

Another useful application for the vehicle lifting system is illustrated in FIG. 8, where a fallen tree T_{F} or other obstruction blocks travel of the user vehicle V_{U} along a roadway, thus necessitating a U-turn to reverse the vehicle's travel direction toward an alternate route. If the roadway is especially narrow, or if other traffic coming up behind the user vehicle constricts the available space in which to turn around, the actuators of the lifting system can be extended to raise the ground wheels 12, 14 slightly off the roadway, for example by the same height mentioned for the anti-theft and parking applications, followed by driven rotation of the two driven auxiliary wheels 30 in unidirectional fashion to shift the vehicle laterally over into the available lane of opposing travel direction, as shown in FIG. 8A. Once in this lane, the two driven auxiliary wheels 30 are then driven in opposite directions to one another, which causes the vehicle to swivel about an upright axis centered between the two driven auxiliary wheels, as shown in FIG. 8B. This bidirectional driving of the driven auxiliary-wheels 30 in opposite directions is continued until the vehicle has swiveled 180-degrees about the upright axis, thus reversing the vehicle's travel direction. The lifting mechanisms are then retracted upwardly into their stowed positions, thereby returning the primary ground wheels 12, 14 to ground level where the powered primary ground wheels can be driven by the vehicle powertrain to convey the car in its newly facing direction in the appropriate travel lane. This 180-degree swivel capability, preceded by an optional lateral shift from an original lane of travel to another lane of reverse travel direction, thus enables the vehicle to reverse its facing direction in much tighter spatial confines than a conventional U-turn, regardless of whether this is done to avoid a roadway obstruction, or to change travel direction for any other reason or motivation. This swivel-based U-turn functionality if especially useful for vehicle's with long wheelbases (limousines, vans, minivans, trucks, etc.).

Another useful application for the vehicle lifting system is to enable escape of a vehicle from a bogged down state in mud, snow sand or other difficult or unstable terrain where one or more of the primary ground wheels of the vehicle are slipping, and unable to gain traction. Here, all or a subset of the actuators of the lifting system can be extended to raise at least the one or more slipping primary ground wheels out of the problematic terrain, whereupon the vehicle operator or other assistive person(s) can place suitable traction aids or ground filler (wood blocks, floor mats, sand or other particulate, etc.) under the lifted primary ground tire, after which the extended actuators are collapsed to lower the primary ground wheels back into ground contact, whereupon the vehicle can be driven out of its stuck position via the improved traction gained by the applied traction aid or filler.

While the examples in FIGS. 1 and 6 place the driven auxiliary wheels at the midpoint of the ground engagement units, and each have two idler wheels situated on opposite sides of the driven auxiliary wheel near the ends of the ground engagement unit, another example may instead relocate the motor driven auxiliary wheel of FIG. 6 to one end of the ground engagement unit, and have only a singular idler wheel disposed at the other opposing end of the ground engagement unit, thereby reducing the overall quantity of auxiliary ground wheels. In other embodiments, idler wheels may be omitted, and replaced with non-rotating shoes attached to the undersides of the frame bars 34 to ride atop the ground surface in sliding fashion, rather than the rolling contact of the illustrated idler wheels. The shoes may be made of hard rubber, plastic or other wear material. Each frame bar 34 may have two separate shoes, one at each end, or a singular full-length shoe spanning a full or substantially full length of the frame bar's underside.

While the illustrated embodiment employs hydraulic actuators that linearly displace the ground engagement units between their deployed and stowed positions, alternative embodiments may employ non-linear motion for deployment and retraction of the ground engagement units, for example using foldable legs directly or indirectly attached to the chassis and carrying the ground engagement units, and actuated between a folded-up position stowing the ground engagement units, and a folded-down position deploying the ground engagement units. In a non-limiting example, the actuators may comprise a combination of said foldable legs with one or more motorized winches operable to pull one or more steel cables to lower the foldable legs and thereby lift the primary ground wheels from the ground, and to gradually let-out the cable(s) in controlled braking fashion to raise the foldable legs and thereby lower the primary ground wheels back to the ground.

Regardless of the linear, folding or other controlled motion used to transition to the ground engagement units between the deployed and stowed positions, and regardless of the type of actuator used to control such motion, the lifting mechanisms may be built into the vehicle itself at the time of the vehicle's manufacture, or installed thereon as an aftermarket accessory. In the latter scenario, the front and rear lifting mechanisms may be mounted to a shared subframe, or separate respective subframes, each to be welded, bolted or otherwise to attached to the vehicle chassis during aftermarket installation. Therefore, the present invention encompasses not only a self-lifting vehicle, but also a separate lifting device for installation on a vehicle to convert same into a self-lifting vehicle.

Since various modifications can be made in my invention as herein above described, and many apparently widely different embodiments of same made, it is intended that all matter contained in the accompanying specification shall be interpreted as illustrative only and not in a limiting sense.

1. A lifting device for a vehicle comprising a chassis, and a plurality of primary ground wheels for rollably supporting said chassis on an underlying ground surface in a normal travel mode of said vehicle, said primary ground wheels including front and rear wheels spaced apart in a longitudinal direction of the vehicle, said device comprising:
front and rear lifting mechanisms installed, or configured for installation, in an undercarriage of said vehicle in respective positions residing proximate opposing front and rear ends of the vehicle, each of said lifting mechanisms comprising:
one or more actuators directly or indirectly attached, or configured for direct or indirect attachment, to the chassis of the vehicle; and
a ground engagement unit attached to said one or more actuators and movable downwardly away from said chassis by operation of said one or more actuators to force said one or more ground engagement units downwardly against the ground surface and thereby lift the chassis upwardly away from said ground surface;
said ground engagement unit comprising:
a frame spanning, or arranged to span, in a transverse direction of transverse relation to the longitudinal direction of the vehicle;
a driven auxiliary wheel; and
a dedicated drive motor for said driven auxiliary wheel;
wherein two driven auxiliary wheels are of the front and rear lifting mechanisms are operable in at least a bidirectional manner rotating in opposite directions to one another.

2. The device of claim 1 wherein the two driven auxiliary wheels are also operable in a unidirectional manner rotating in a same direction as one another.

3. The device of claim 1 wherein each driven auxiliary wheel is drivable in two opposing directions.

4. The device of claim 1 wherein each ground engagement unit further comprises at least one idler wheel.

5. The device claim 4 wherein each ground engagement unit comprises two idler wheels, and the driven auxiliary wheel is located between said two idler wheels.

6. The device of claim 1 comprising a flood sensor operable to detect flood conditions and trigger operation of the one or more actuators of each lifting mechanism in response to detection of said flood conditions.

7. The device of claim 1 comprising an overhead obstruction sensor operable to detect an overhead obstruction above the vehicle, and to limit operation of the actuators based on available clearance between the vehicle and said overhead obstruction.

8. The device of claim 1 wherein the driven auxiliary wheel of each lifting mechanism resides centrally of the frame thereof.

9. The device of claim 1 wherein the one or more actuators of each lifting mechanism comprise two actuators attached to the frame thereof at spaced apart positions in the transverse direction.

10. The device of claim 1 wherein the one or more actuators of each lifting mechanism comprise two actuators coupled to the frame thereof on opposite sides of the driven auxiliary wheel.

11. The device of claim 1 in combination with said vehicle, wherein the front and rear lifting mechanisms are installed in the undercarriage of said vehicle at said positions residing proximate said opposing front and rear ends of the vehicle, with the one or more actuators directly or indirectly attached to the chassis of the vehicle.

12. A method of using the combination of claim 11 for flood damage prevention, the method comprising, upon detection or warning of flood conditions, operating the one or more actuators of each lifting mechanism to lift the primary ground wheels from the ground surface and thereby elevate the chassis to a safe level beyond detected or anticipated flood levels.

13. A method of using the combination of claim 11 for parallel parking assistance, the method comprising, with said vehicle situated beside an available parking space situated between two parked vehicles, operating the one or more actuators of each lifting mechanism to thereby lift the primary ground wheels from the ground surface, and using the driven auxiliary wheels to drive the vehicle laterally into said available parking space.

14. A method of using the combination of claim 11 to perform a U-turn, the method comprising, operating the one or more actuators of each lifting mechanism to thereby lift the primary ground wheels from the ground surface, and using the driven auxiliary wheels to swivel the vehicle about an upright axis.

15. A method of using the combination of claim 11 to aid in escape of the vehicle from a bogged-down scenario in which one or more of the primary ground wheels is slipping in difficult terrain, the method comprising, operating the one or more actuators of at least one of the lifting mechanism to lift said one or more slipping primary ground wheels, placing a filler or traction aid under said one or more slipping primary ground wheels, operating said one or more actuators of said at least one of the lifting mechanisms to lower said one or more slipping primary ground wheels back down onto the placed filler or traction aid, and operating the primary ground wheels to escape the bogged-down scenario using improved traction of said one or more slipping primary ground wheels on the filler or traction aid.
